(19) United States
(12) Patent Application Publication
(10) Pub. No.: US 2022/0244169 A1
(43) Pub. Date: Aug. 4, 2022

(54) Reflectometer, spectrophotometer, ellipsometer and polarimeter systems including a wavelength modifier

(71) Applicant: J.A. WOOLLAM CO., INC., Lincoln, NE (US)

(72) Inventors: Ping He, Lincoln, NE (US); Martin M. Liphardt, Lincoln, NE (US); Jeremy A. Van Derslice, Dwight, NE (US); Craig M. Herzinger, Lincoln, NE (US); Jeffrey S. Hale, Lincoln, NE (US); Brian D. Guenther, Lincoln, NE (US); Duane E. Meyer, Bennet, NE (US); Stefan Schoeche, Lincoln, NE (US); James D. Welch, Omaha, NE (US)

(73) Assignee: J.A. WOOLLAM CO., INC., Lincoln, NE (US)

(21) Appl. No.: 17/300,660

(22) Filed: Sep. 16, 2021

Related U.S. Application Data
(60) Provisional application No. 63/143,187, filed on Jan. 29, 2021.
(60) Provisional application No. 63/259,830, filed on Aug. 17, 2021.

(51) Int. Cl. G01N 21/21; G02B 27/42

(52) U.S. Cl. CPC G01N 21/211; G01N 2201/0634; G01N 2201/021; G02B 27/4233

(57) ABSTRACT

Ellipsometer, polarimeter, reflectometer and spectrophotometer systems including one or more wavelength modifiers which convert wavelengths provided by a source of electromagnetic radiation to different wavelengths for use in investigating a sample, and/or which a detector thereof can detect.

This Application Claims Benefit of Provisional Application 63/143,187 Filed Jan. 29, 2021 and of 63/259,830 Filed Aug. 17, 2021.

### TECHNICAL FIELD

Ellipsometer, polarimeter, reflectometer and spectrophotometer systems including one or more wavelength modifiers which convert wavelengths provided by a source of electromagnetic radiation to different wavelengths for use in investigating a sample, and/or which a detector thereof can detect.

### BACKGROUND

The use of electromagnetic radiation to investigate samples is well known. Reflectometer, spectrophotometer, ellipsometer, and polarimeter systems, for instance, direct a beam of electromagnetic radiation to interact therewith, (in reflection and/or transmission), a sample, which beam then enters a detector. Detected changes in Intensity (in reflectometer and spectrophotometer systems), and also Polarization State (in ellipsometer, and polarimeter systems), as a result of said interaction provide insight to properties of the sample. Properties such as absorption constant, ellipsometric Psi and Delta etc. are evaluated, typically by performing a mathematical regression of accumulated data onto a mathematical model of the sample.

It has been conventional practice to provide a source of electromagnetic radiation comprising desired wavelengths and cause it to direct a beam thereof so that it interacts with a sample, then enters a detector. However, when the wavelengths provided are, for instance, in the IR or THZ range detecting them requires specialized detector systems (eg. Golay Cells or Bolimeters etc.). Detectors of IR and THZ wavelengths are far more difficult to utilize than are, for instance, Solid State Detectors which are suited for detecting Visual range Wavelengths. The present Invention recognizes this and provides Wavelength Modifiers which, for instance, receive IR or THZ Wavelengths and provide, for instance, Visual Range Wavelengths that are derived from the IR and THZ wavelengths. Further, it is possible that an investigator using a system that provides say IR or THZ wavelengths might want to easily extend investigation to include, say Visual Wavelengths, In such a case a Wavelength Modifier can be applied prior to a Sample. An example of a currently available Wavelength Modifier, which converts MIR range wavelengths to the Near-Visible Wavelengths is produced by a Danish Company NLIR. A Data Sheet therefore is provided in the Information Disclosure.

The Present Invention, while focused on the use of Wavelength Modifiers in ellipsometer, polarimeter, reflectometer and spectrophotometer systems for Patentability, also has as collateral concerns topics such as Sources of electromagnetic radiation and Detectors thereof. Regarding Up-Conversion, Wavelength Modifiers apparently work by taking advantage of properties of Surface states in Semiconductors. In a recent Press Release, Mona Jarrahi of UCLA's Computer and Electrical Engineering Dept. reported that when struck by incoming light, electrons in a Semiconductor Lattice experience an increase in energy allowing them to jump around in the Lattice. An Electric Field boots energy even further. When the electrons unload their energy via Photon Emission, it is of a different Wavelength.

Continuing, it is always of benefit to investigate a sample with multiple angles-of-incidence of the beam to a sample surface, and with as many wavelengths as possible. While no Source is identified as preferred herein (other than as determined as compatible for use with Wavelength Modifiers), the later point can be addressed by use of a source of a beam of electromagnetic radiation termed a supercontinuum laser. See patent Ser. No. 11/035,729 to Van Derslice for more insight to Supercontinuum Sources. While the formation of a supercontinuum laser spectrum is the result of many complex non-linear effects, such need not concern us as regards the present invention which is not dependent on how a supercontinuum is produced, only that it is, and can be applied in such as a reflectometer, spectrophotometer, ellipsometer or polarimeter. Again, the Present Invention concerns the use of Wavelength Modifiers in such Sample Investigation systems.

A Search of Patents for the application of Wavelength Modifiers in ellipsometer, polarimeter, reflectometer and spectrophotometer systems has turned up nothing. However, in previous Patent efforts by the Inventors in a closely related area, Patents were found and known, hence disclosed herein. For instance:
U.S. Pat. No. 8,422,519 to Knight et al.;
U.S. Pat. No. 8,718,104 to Clowes et al.;
Published App. No. 2014/0233091 by Clowes et al.;
U.S. Pat. No. 7,345,762 to Liphardt et al.;
U.S. Pat. No. 6,104,488 to LeVan
   are disclosed. Additional Patent references identified in a computer Search are:
Searching for (Supercontinuum Laser and Ellipsometer) provided five U.S. Pat. Nos. 9,080,971, 8,873,054, 8,441,639, 8,031,337 and 7,570,358, and six Published Applications, No. 2015/0323316, 2015/0036142, 2013/0222795, 2011/0069312, 2009/0262366 and 2008/0239265; and
Searching of (Supercontinuum & Laser and Ellipsometer and Speckle) provided no Patents and only four Published Applications, Nos. 2015/0058813, 2015/0046121, 2015/0046118 and 2015/0330770.
   Also, known Patents and Published Applications relating to Speckle Reduction are: U.S. Pat. No. 6,895,149 to Jacob et al.; U.S. Pat. No. 7,522,331 to Lapchuk et al.; US 2013/0027673 by Moussa; US 2006/0238743 by Lizotte et al. and US 2013/0010365 by Curtis.

Further, in prosecution of Parent application Ser. No. 14/757,280 the Examiner identified:

| | |
|---|---|
| Hilfiker et al. | US2012/0057158; |
| Herzinger | US2013/0026368; |
| Pandev | US2013/0304408; |
| Ostermeyer | US2013/0268336; |
| Johs | US2015/0219497; |
| Moriva et al. | US2009/0267003; |
| Grejeda | US2014/0304963; |
| Yamaguchi et al. | US2013/0063700. |

Also known is an article titled “A New Spectrometer Using Multiple Gratings With A Two-Dimensional Charge-Coupled Diode Array Detector”, Review of Scientific Instruments, Han et al., Vol. 74, No. 6, June 2003, describes a special grating that consists of three laterally stacked sub-gratings to generate three wavelength ranges.

It is to be appreciated that Wavelength Modifiers can be applied after a Stage of a Sample Investigation System to change wavelengths provided by a Source thereof into wavelengths a Detector can detect after interaction with a Sample. It is to also be appreciated that a Wavelength Modifier can be placed before a Stage in a Sample Investigation System to shift Wavelengths used in Sample Investigation. The later effect can be used to extend the range of, for instance, IR and THZ Systems into the Visible range.

Even in view of the known prior art need remains for the benefits provided by using Wavelengths Modifiers in ellipsometer, polarimeter, reflectometer and spectrophotometer Sample Investigation Systems, either on the Detector side of a system stage, or on the Source side thereof.

### DISCLOSURE OF THE INVENTION

To begin, it must be understood that, as in Co-Pending application Ser. No. 16/602,088, the Present Invention Sample Investigation System, and Methods of Use can be comprised of, and derived from various combinations in at least three different sub-invention areas, these being:
application of systems of detectors in combinations that can be optimized for use in various ranges of electromagnetic radiation wavelengths;
use of a supercontinuum laser for providing a beam of coherent electromagnetic radiation over a wavelength range of at least 400-4400 nm, possibly in combination with other sources of electromagnetic radiation over extended wavelength ranges; and
application of a speckle reducer with supercontinuum laser sources to effectively provide a more consistent Intensity vs. Position in a beam of electromagnetic radiation derived from the supercontinuum laser output in Ellipsometers, Reflectometers, Spectrophotometers and the like systems.
   The Presently disclosed Invention is, however, further comprised from additional Sub-invention areas, namely:
most importantly, application of Wavelength Modifiers which receive, for instance, relatively longer wavelength electromagnetic radiation (eg. in the Infrared (IR) and Terahertz (THZ) ranges) which, for instance, Solid State Detector Elements cannot detect, and providing relatively shorter wavelength electromagnetic radiation which, for instance, Solid State (or other type) Detector Elements can detect;
application of Wavelength Modifiers which receive relatively shorter wavelength electromagnetic radiation which Golay Cell, Bolometer, Micro-Bolometer a thermocouple; photoconductive material; photoconductive material; Deuterated Triglycine Sulfate (DTGS); HgCdTe (MCT); LiTaO3; PbSe; PbS; and InSb etc. detectors have a problem detecting, and providing relatively longer wavelength electromagnetic radiation which they can detect.
   Additional sub-invention areas are:
application of supercontinuum lasers source that provide wavelengths up to about 18000 nm;
application of additional types of sources of electromagnetic radiation in combination with, or in substitution for supercontinuum lasers, to expand the wavelength range over which a present invention Sample Investigation System can be used, (eg. Nernst Glower and Globar and other Sources which can provide wavelengths up to between 14000 nm and 50000 nm, respectively, or other possible sources which include DTHS; Laser stabilized Arc Lamps, Hg Arc Lamps, Fixed or Tunable Quantum Cascade Lasers, QTH and Xe lamps, laser stabilized arc lamps, other laser driven source);
application of a supercontinuum lasers in Fourier transform infrared sources by the combining thereof with a Michelson Interferometers, which it is believed has not been previously disclosed in the context of application in Ellipsometer, Reflectometer, Spectrophotometer and the like systems in combination with other distinguishing factors;

Said present invention sub-categories, in various combinations are believed provide new, novel and non-obvious Sample Investigation Systems and enable new, non-obvious and useful Methods of Use thereof.

The present invention as Claimed in this Application is focused on a sample investigation system selected from the group consisting of:
an ellipsometer;
a polarimeter;
a reflectometer; and
a spectrophotometer;
   for use in investigation samples with electromagnetic radiation; said system comprising:
a source (LS) of electromagnetism;
a stage (STG) for supporting a sample; and
a detector (PA) which comprises detector elements (DE's).
   In an important embodiment, said system source (LS) provides long wavelength electromagnetic radiation in the IR and THZ ranges, and said detector comprises solid state elements (DE's) which cannot detect said IR and THZ wavelengths. Said system is, however, characterized by the presence of, prior to said detector (PA), at least one wavelength modifier (WM) for accepting electromagnetic radiation of wavelengths outside the range of said detector (PA) detector elements (DE's) can detect, and providing output electromagnetic radiation based thereupon of wavelengths which said detector elements (DE's) can detect.
   Said system can further comprise polarization state generator (PSG) and polarization state analyzer (PSA) components before and after said stage (STG) respectively, and the system is then an ellipsometer.
   Said system can provide that the at least one wavelength modifier (WM) accepts electromagnetic radiation comprising wavelengths in the IR and THZ ranges and outputs electromagnetic radiation with wavelengths in the visible wavelength range.
   Said system can provide that the at least one wavelength modifier (WM) accepts electromagnetic radiation comprising wavelengths in the far-IR ranges and outputs electromagnetic radiation with wavelengths in the visible wavelength range.
   Said system can provide that the at least one wavelength modifier (WM) accepts electromagnetic radiation comprising wavelengths in the mid-IR ranges and outputs electromagnetic radiation with wavelengths in the visible wavelength range.
   Said system can provide that the at least one wavelength modifier (WM) accepts electromagnetic radiation comprising wavelengths in the near-IR ranges and outputs electromagnetic radiation with wavelengths in the visible wavelength range.
   Said system can further comprises a dispersion optics (DO) between said stage and detector for spatially separating different wavelengths for presentation to a multiple element (DE's) detector (PA).
   Said wavelength modifier can be placed between a selection from the group consisting of:
between said source (LS) and said stage (STG);
between said stage (STG) and said dispersive optics (DO);
between said dispersive optics (DO) and said detector (PA).

The present invention is also a sample investigation system selected from the group consisting of:
an ellipsometer;
a polarimeter;
a reflectometer; and
a spectrophotometer;
   for use in investigation samples with electromagnetic radiation; said system comprising:
a source (LS) of electromagnetism;
a stage (STG) for supporting a sample; and
a detector (PA).
   Said system source (LS) provides electromagnetic radiation in a wavelength range, longer or shorter than said detector elements (DE's) can detect; and said system is characterized by the presence of, prior to said detector (PA), at least one wavelength modifier (WM) for accepting electromagnetic radiation of wavelengths outside the range of said detector (PA) said state elements (DE's) can detect, and providing output electromagnetic radiation based thereupon of wavelengths which said solid state elements (DE's) can detect.
   Said system can provide that the source (LS) provides electromagnetic radiation with wavelengths in a range selected from:
ultraviolet;
visual;
far-infrared;
mid-infrared;
terahertz;
   and that said detector detects wavelengths in a range selected from:
ultraviolet;
visual;
far-infrared;
mid-infrared;
terahertz;
   wherein said selected detected wavelength range is different from that provided by said source (LS).
   Said system can provide that the source provides wavelengths in a range selected from:
far-infrared;
mid-infrared;
near infrared; and
terahertz;
   and the wavelength modifier provides wavelengths in a range selected from the group consisting of:
ultraviolet; and
visual.

The present invention is also a method of investigating a sample comprising the steps of:
a) providing:
   an ellipsometer;
   a polarimeter;
   a reflectometer; and
   a spectrophotometer;
      for use in investigation samples with electromagnetic radiation; said system comprising:
a source (LS) of electromagnetism;
a stage (STG) for supporting a sample; and
a detector (PA) comprising detector elements (DE's);
   wherein said system source (LS) providing electromagnetic radiation in a wavelength range, longer or shorter than said detector elements (DE's) can detect; and said system is characterized by the presence of, prior to said detector (PA), at least one wavelength modifier (WM) for accepting electromagnetic radiation of wavelengths outside the range of said detector (PA) said state elements (DE's) can detect, and providing output electromagnetic radiation based thereupon of wavelengths which said solid state elements (DE's) can detect.
   Said method continues with:
b) placing a sample to be investigated on said stage (STG);
c) causing said source (LS) to provide electromagnetic radiation comprising wavelengths said detector elements (DE'S) cannot detect and direct a beam thereof toward said sample;
d) causing said wavelength modifier to receive electromagnetic radiation wavelengths from said sample which were provided by said source (LS) and, and modify them to wavelengths said detector elements (DE's) can detect;
e) causing said detector elements to detect the modified electromagnetic radiation and provide output data;
f) analyzing said output data to determine sample characteristics.
   Said method can provide that said system further comprises a dispersive optics (DO) which spatially separates different electromagnetic wavelengths.
   Said wavelength modifier (WM) can be positioned between said source (LS) and said stage, or between said stage (STG) and said dispersive optic, (DO), or between said dispersive optic (DO) and said detector (PA).

Another method of investigating a sample with electromagnetic radiation of different wavelengths than provided by a source thereof, comprising the steps of:
a) providing:
   an ellipsometer;
   a polarimeter;
   a reflectometer; and
   a spectrophotometer;
      for use in investigation samples with electromagnetic radiation; said system comprising:
a source (LS) of electromagnetism;
a stage (STG) for supporting a sample; and
a detector (PA) comprising detector elements (DE's).
   Said system source (LS) provide electromagnetic radiation in a wavelength range, longer or shorter than said detector elements (DE's) can detect.
   Said system being characterized by the presence of, prior to said stage (STG), a wavelength modifier (WM).
   Said Method continues with:
b) placing a sample to be investigated on said stage (STG);
c) causing said source (LS) to provide electromagnetic radiation and direct a beam thereof toward said sample;
d) causing said wavelength modifier (WM) to receive wavelengths of electromagnetic radiation in a first range as provided by said source (LS) thereof, and emit wavelengths in a modified range;
e) causing said detector elements (DE's) to detect the modified electromagnetic radiation wavelengths after interacting with said sample (MS); and
f) analyzing said output data to determine sample characteristics.
   Said method can further comprise a step (c′) between steps c) and d) of placing a second wavelength modifier (WM) between said stage (STG) and said Detector (PA) to place wavelengths from said sample (MS) in a range detector elements (DE's) in said detector (PA) can detect.

In view of the primary invention Claimed herein (use of Wavelength Modifiers (WM) to change wavelengths of electromagnetic radiation at points within a Sample Investigation System, it is to appreciated that any Source of electromagnetic radiation can be utilized in the Present Inventions to provide electromagnetic radiation of desired Wavelengths. For instance, Continuum Sources such as Ar, Xe and He Discharge Lames in the UV Region; and Tungsten Filament Lamps in the Visible; and Blackbody radiators, Nernst and Globar sources in the Infrared ranges can be applied. Line Sources such as Hg and Na Lamps in the UV and Visible ranges, and Lasers in the and Visible and IR ranges can also be applied. Benefits can, however, be derived from the fact that the Intensity of a beam of electromagnetic radiation from a supercontinuum laser is generally much higher over a larger range of wavelengths than is the case from other sources of electromagnetic radiation conventionally used in ellipsometric and the like applications. As the present invention system of detectors can provide optimized detection of electromagnetic radiation in specific ranges of wavelengths (including modified wavelengths produced by wavelength modifiers—usually from longer to shorter, but can be from shorter to longer wavelengths), the present invention provides utility in the form of allowing a user thereof to conveniently investigate samples over a large range of wavelengths without the necessity of reconfiguring the system with different sources and detectors of electromagnetic radiation. However, other known sources provide wavelengths longer than can be currently produced by supercontinuum lasers, but will certainly be produced by improved—supercontinuum lasers in the future, hence, the present invention also comprises use thereof when necessary to enable sample investigation at longer/shorter wavelengths, until improved supercontinuum lasers become available. It is noted that an increase in wavelength range from about 400-2500 nm about five years ago, supercontinuum lasers available presently provide wavelengths up to at least 4400 nm. For instance NP Photonics SpectraChrome 1000 Mid-IR Supercontinuum Lasers. It is also noted that Supercontinuum Lasers that provide wavelengths up to about 18000 nm are available, although Intensity of the wavelengths drops with at the longest wavelengths. A Source from IPG Photonics (CLPF-2500-SC IDFG Series) shows a Plot out to 18 Microns for instance. Many such Sources however, extend only to about 5000 nm at most. The present invention is to be considered to encompass any such a possible Supercontinuum Laser wavelength range.

### Sample Investigation Systems

With the foregoing in mind, the present invention can first be described as a sample investigation system selected from the group consisting of:
a reflectometer;
a spectrophotometer;
an ellipsometer; and
a polarimeter;
   comprising:
a) a source of a spectroscopic beam of electromagnetic radiation;
b) a stage for supporting a sample; and
c) a detector system for monitoring electromagnetic radiation provided from a single sample.
   Said system is distinguished in that:
   said source of a spectroscopic beam of electromagnetic radiation is a supercontinuum laser that provides a high intensity, highly directional coherent spectrum of electromagnetic radiation wavelengths within a range comprising 400 to at least 4400 nm, that results from interaction of a pulsed laser and non-linear processes to cause extensive spectral broadening;
   and in that said sample investigation system is characterized by at least one selection from a Primary Selection Group, said Primary Selection Group being:

### PRIMARY SELECTION GROUP

in use, said source of a spectroscopic beam of electromagnetic radiation directs a beam provided thereby to a sample placed on said stage for supporting a sample, at an angle thereto, but does not involve said beam passing through a combination beam splitter and objective lens, in that order;
in use, fluorescence caused to occur by an illumination beam of electromagnetic radiation is not detected by a detector for spatially resolving radiation emitted by an object to be examined, and an illumination beam path between an illumination means and an object to be examined, and a detection beam path between said object to be examined and a detector do not comprise illumination optics which are designed to generate a light sheet of illumination radiation extending transverse to the illumination beam path, and wherein the axis of the detection beam path is oriented substantially perpendicular to a section plane of light sheet and the object to be examined, and an illumination beam path between an illumination means and an object to be examined, and a detection beam path between said object to be examined and a detector do not comprise illumination optics which are designed to generate a light sheet of illumination radiation extending transverse to an axis of the illuminating beam path, and the detection beam path is not oriented at an angle diverging from θ degrees to a section plane of the light sheet and of the object to be examined; and
in use said system does not utilize a supercontinuum source comprised of a pulsed laser adapted to pump into a photonic crystal fiber made from chalogenide glasses as a substantial element; or from a pumping CO2 laser adapted to fire into a photonic crystal fiber formed in part from at least one selection from the group of: AlClxBr(1-x), NaCl and ZnSe; or a system comprising a Titanium:Saphire laser adapted to fire femtosecond pulses through a non-linear optical element disposed in an inert gas in a gas containment cell, such that a second harmonic pulse is produced and generates supercontinuum terahertz radiation.
   It is noted that two or all three selections can be made.

Said sample investigation system can further comprise a speckle reducer; said speckle reducer serving to reduce wild swings in intensity of electromagnetic radiation as a function of time and position in a beam, resulting from interference effects between different coherent wavelengths in said extensively broadened spectrum.

Said sample investigation system can further comprise a polarization state generator between said source of a beam of electromagnetic radiation and said stage for supporting a sample, and a polarization state analyzer between said stage for supporting a sample and said detector, and the system is an ellipsometer or polarimeter, and optionally further comprises a compensator in the polarization state generator and/or said polarization state detector.

Said sample investigation system can comprise a speckle reducer in the form of a multimode fiber.

Said sample investigation system can comprise a speckle reducer in the form of a beam diffuser.

Said sample investigation system can comprise a speckle reducer in the form of a fly's-eye beam homogenizer.

Said sample investigation system comprises a speckle reducer in the form of a rotating beam diffuser.

Said sample investigation system can comprise a speckle reducer in the form of a piezoelectric electric crystal driven beam diffuser.

Said sample investigation system can comprise a speckle reducer in the form of an electronic means to shorten temporal coherence length.

Said sample investigation system can further comprise at least one selection from the group consisting of:
said system further comprises a Michelson interferometer and said supercontinuum laser source of electromagnetic radiation is in functional combination therewith, said source being an FTIR source;
said system further comprises a wavelength modifier for accepting electromagnetism of relatively long (short) wavelengths, and providing output of shorter (longer) wavelengths which detector element(s) can detect;
said detector system comprises a single element;
said detector system comprises a multiplicity of detector elements which can detect wavelengths exiting from said wavelength modifier when relatively longer (shorter) wavelengths are entered thereinto, and in which said detectable wavelengths are guided into said detector elements via at least one selection the group consisting of:
   at least one beam splitter;
   at least one combined dichroic mirror and prism; and
   at least one grating; and
said system further comprises a second source that provides wavelengths within a range longer or shorter than that provided by said supercontinuum laser.

A present invention method of investigating a sample can comprise:

a) providing a sample investigation system selected from the group consisting of:
a reflectometer;
a spectrophotometer;
an ellipsometer; and
a polarimeter;
   comprising:
a′) a source of a beam of a spectroscopic beam of electromagnetic radiation;
b′) a stage for supporting a sample; and
c′) a detector system for monitoring electromagnetic radiation provided from a single sample.
   Said system is distinguished in that said source of a high intensity, highly directional spectroscopic beam of electromagnetic radiation is a supercontinuum laser that provides a coherent spectrum of electromagnetic radiation wavelengths within a range comprising 400 to at least 4400 nm, that results from interaction of a pulsed laser and non-linear processes to cause extensive spectral broadening, said system further comprising a second source that provides wavelengths within a range longer or shorter than that provided by said supercontinuum laser, said system being configured so that both sources provide electromagnetic radiation to substantially the same location on said sample as said supercontinuum source.
   Said system further comprises a speckle diminisher in the form of a selection from the group consisting of:
a multimode fiber;
a beam diffuser;
a fly's-eye beam homogenizer;
a rotating beam diffuser;
a piezoelectric electric crystal driven beam diffuser;
an electronic means to shorten temporal coherence length;
   said speckle reducer serving to reduce wild swings in intensity of electromagnetic radiation as a function of position in a beam resulting from interference effects between different coherent wavelengths in said extensively broadened spectrum.
   Said sample investigation system is characterized by at least one selection from the group consisting of:

### The Primary Selection Group

Said method continues with:

b) causing a spectroscopic beam of speckle reduced electromagnetic radiation provided by said supercontinuum laser and speckle reducer to interact with a sample on said stage, then enter said detector system and/or causing electromagnetic radiation provided by said second source interact with a sample on said stage and enter said Detector;

c) analyzing data provided by said detector to characterize said sample.

Said detector can comprise a system of at least two detectors and means for distributing a portion of said spectroscopic beam to each based on wavelength.

Another recitation of a sample investigation system selected from the group consisting of:
a reflectometer;
a spectrophotometer;
an ellipsometer; and
a polarimeter;
   comprising:
a) a source of a spectroscopic beam of electromagnetic radiation;
b) a stage for supporting a sample; and
c) a detector system for monitoring electromagnetic radiation.
   Said system is distinguished in that:
   said source of a spectroscopic beam of electromagnetic radiation is a supercontinuum laser that provides a high intensity, highly directional coherent spectrum of electromagnetic radiation wavelengths within a range comprising 400 to at least 4400 nm, that results from interaction of a pulsed laser and non-linear processes to cause extensive spectral broadening, said system further comprising a second source that provides wavelengths within a range longer or shorter than that provided by said supercontinuum laser, said system being configured so that both sources provide electromagnetic radiation to substantially the same location on said sample as said supercontinuum source;
   and in that said sample investigation system is characterized by:

### The Primary Selection Group

Said system further comprises a speckle reducer in the form of a selection from the group consisting of:
a multimode fiber;
a beam diffuser;
a fly's-eye beam homogenizer;
a rotating beam diffuser;
a piezoelectric electric crystal driven beam diffuser;
an electronic means to shorten temporal coherence length;
   said speckle reducer serving to reduce wild swings in intensity of electromagnetic radiation as a function of time and position in a beam, resulting from interference effects between different coherent wavelengths in said extensively broadened spectrum.
   Said system can also further comprise a polarization state generator between said source of a beam of electromagnetic radiation and said stage for supporting a sample, and a polarization state analyzer between said stage for supporting a sample and said detector, and the system is an ellipsometer or polarimeter, said system optionally further comprising a compensator in the polarization state generator and/or said polarization store detector.

Said sample investigation system can comprise a speckle reducer in the form of a multimode fiber, a beam diffuser, a fly's-eye beam homogenizer, a rotating beam diffuser, a piezoelectric electric crystal driven beam diffuser or an electronic means to shorten temporal coherence length.

Where applicable, the detector system in any embodiment can be comprised of a selection from the group consisting of:
a Golay cell;
a Bolometer;
a thermocouple;
is comprised of photoconductive material;
is comprised of photovoltaic material;
is comprises of Deuterated Triglycine Sulfate (DTGS);
is comprised of HgCdTe (MCT);
is comprised of LiTaO3;
is comprised of PbSe;
is comprised of PbS; and
is comprised of InSb;
   said group further comprising:
said detector system comprises a multiplicity of detector elements which can detect wavelengths guided thereinto into via at least one selection the group consisting of:
   at least one beam splitter;
   at least one combined dichroic mirror and prism; and
   at least one grating.

Another recitation of a sample investigation system for use in investigating samples over a wavelength range comprising between 400 nm up to at least 50000 nm, said sample investigation system being selected from the group consisting of:
a reflectometer;
a spectrophotometer;
an ellipsometer; and
a polarimeter;
   and comprising:
a) a source of a spectroscopic beam of electromagnetic radiation;
b) a stage for supporting a sample; and
c) at least one detector system for monitoring electromagnetic radiation.
   Said source of a spectroscopic beam of electromagnetic radiation being selected from the group consisting of:
a supercontinuum laser;
a Nernst Glower;
a Globar;
a laser stabilized arc lamp;
a HG arc lamp; and
a fixed or tunable quantum cascade laser; and
   which provide wavelengths in the infrared and/or terahertz ranges.
   Said at least one detector system can comprise detector element(s) which are incapable of detecting long electromagnetic radiation wavelengths over at least part of the infrared and terahertz ranges. In this case said sample investigation system further comprises at least one wavelength modifier which, in use, accepts relatively long (short) wavelength electromagnetic radiation which the element(s) in said at least one detector system are incapable of detecting, and providing as output shorter (longer) wavelengths which said detector element(s) are capable of detecting, and entering said detectable wavelengths into said at least one detector system comprised of element(s) which can detect said shorter (longer) wavelength electromagnetic radiation.

Another recitation of a method of investigating a sample comprising the steps of:
a) providing a sample investigation system for use in investigating samples over a wavelength range comprising between 400 nm to at least 50000 nm, said sample investigation system being selected from the group consisting of:
   a reflectometer;
   a spectrophotometer;
   an ellipsometer; and
   a polarimeter;
      and comprising:
a′) a source of a spectroscopic beam of electromagnetic radiation;
b′) a stage for supporting a sample; and
c′) at least one detector system for monitoring electromagnetic radiation;
   wherein said source of a spectroscopic beam of electromagnetic radiation is selected from the group consisting of:
a supercontinuum laser;
a Nernst Glower;
a Globar;
a laser stabilized arc lamp;
a HG arc lamp; and
a fixed or tunable quantum cascade laser;
   which provide wavelengths in the infrared and/or terahertz ranges.
   Said at least one detector system can comprising detector element(s) which are incapable of detecting long electromagnetic radiation wavelengths over at least part of the infrared and terahertz ranges, and said sample investigation system further comprise at least one wavelength modifier which, in use, accepts relatively long (short) wavelength electromagnetic radiation which the element(s) in said at least one detector system element(s) are incapable of detecting, and providing as output shorter (longer) wavelengths which said detector element(s) are capable of detecting, and entering said detectable wavelengths into said at least one detector system comprised of detector element(s) which can detect said shorter (longer) wavelength electromagnetic radiation.
   Said method continues with:
b) selecting the supercontinuum laser source and further providing a speckle reducing system selected from the group consisting of:
   a multimode fiber;
   a beam diffuser;
   a fly's-eye beam homogenizer;
   a rotating beam diffuser;
   a piezoelectric electric crystal driven beam diffuser; and
   an electronic means to shorten temporal coherence length;
c) placing a sample to be investigated onto said stage for supporting a sample;
d) causing a beam of electromagnetic radiation to be produced by said supercontinuum laser source and interact with said sample, then enter said at least one detector system for monitoring electromagnetic radiation;
   causing said beam of electromagnetic radiation to also interact with said speckle reducing system and said wavelength modifier between said supercontinuum laser source and said at least one detector system comprising element(s) which are incapable of detecting long (short) electromagnetic radiation wavelengths over at least part of the infrared and terahertz ranges;
   such that electromagnetic radiation of wavelength(s) which the element(s) in said at least one detector can detect are entered into said at least one detector system; and
e) analyzing output from said at least one detector to provide insight to characteristics of said sample.

Another method of investigating a sample comprises the steps of:
a) providing a sample investigation system for use in investigating samples over a wavelength range comprising between 400 nm up to at least 50000 nm, said sample investigation system being selected from the group consisting of:
   a reflectometer;
   a spectrophotometer;
   an ellipsometer; and
   a polarimeter;
      and comprising:
a′) a source of a spectroscopic beam of electromagnetic radiation;
b′) a stage for supporting a sample; and
c′) at least one detector system for monitoring electromagnetic radiation.
   Said source of a spectroscopic beam of electromagnetic radiation can be selected from the group consisting of:
a supercontinuum laser;
a Nernst Glower;
a Globar;
a laser stabilized arc lamp;
a HG arc lamp; and
a fixed or tunable quantum cascade laser;
   which provide wavelengths in the infrared and/or terahertz ranges.
   Said at least one detector system can comprise detector element(s) which are incapable of detecting electromagnetic radiation wavelengths over at least part of the infrared and terahertz ranges;
   Said sample investigation system can further comprise at least one wavelength modifier which, in use, accepts relatively long (short) wavelength electromagnetic radiation which the detector element(s) in said at least one detector system are incapable of detecting, and providing as output shorter (longer) wavelengths which said detector element(s) are capable of detecting, and entering said detectable wavelengths into said at least one detector system comprised of element(s) which can detect said shorter wavelength electromagnetic radiation.
   Said method continues with:
b) selecting other than the supercontinuum laser source of electromagnetic radiation;
c) placing a sample to be investigated onto said stage for supporting a sample;
d) causing a beam of electromagnetic radiation to be produced by said source and interact with said sample, then enter said at least one detector system for monitoring electromagnetic radiation;
   causing said beam of electromagnetic radiation to also interact with said wavelength modifier between said source and said at least one detector system comprising detector element(s) which are incapable of detecting long (short)electromagnetic radiation wavelengths over at least part of the infrared and terahertz ranges;
   such that electromagnetic radiation of wavelength(s) which the detector element(s) in said at least one detector can detect are entered into said at least one detector system; and
e) analyzing output from said at least one detector to provide insight to characteristics of said sample.

In any of the foregoing examples, where appropriate, the sample investigation system can provide that the supercontinuum laser source of electromagnetic radiation is in functional combination with a Michelson interferometer; and said detector is selected from the group consisting of:
a Golay cell;
a Bolometer;
a thermocouple;
a detector characterized by comprising a material selected from the group consisting of:
   Deuterated Triglycine Sulfate (DTGS);
   HgCdTe (MCT);
   LiTaO3;
   PbSe;
   PbS;
   InSb; and
   InGaAs.

Another present invention sample investigation system for use in investigating samples over a wavelength range, provides that said sample investigation system being selected from the group consisting of:
a reflectometer;
a spectrophotometer;
an ellipsometer; and
a polarimeter;
   comprising:
a) a source of a beam of a spectroscopic beam of electromagnetic radiation selected from the group consisting of:
   a supercontinuum laser; and
   a source for providing wavelengths longer or shorter than provided by said supercontinuum laser;
b) a stage for supporting a sample; and
c) a detector system for monitoring electromagnetic radiation provided from a single sample.
   Said at least one detector system can comprise detector element(s) which are incapable of detecting long (short) electromagnetic radiation wavelengths over at least part of the source provided range of wavelengths.
   Said system can further require that at least one selection from the group consisting of:
at least one wavelength modifier which, in use, accepts relatively long (short) wavelength electromagnetic radiation which the element(s) in said at least one detector system are incapable of detecting and providing as output shorter (longer) wavelengths which said detector element(s) can detect, the output of which wavelength modifier is entered as detectable wavelengths into said detector system detector element(s); and
a speckle reducer, said speckle reducer serving to reduce wild swings in intensity of electromagnetic radiation as a function of time and position in a beam, resulting from interference effects between different coherent wavelengths in said extensively broadened spectrum;
   be present.

The present invention is then found in use of combinations of
the application of systems of detectors;
the use of a supercontinuum lasers;
the application of a speckle reducers;
the application of additional sources of electromagnetic radiation;
the application of a supercontinuum lasers in Fourier transform infrared sources;
the application of Wavelength Modifiers.

### Detector Systems

The present invention comprises use of both single element and multielement Detectors. When a beam, be it monochromatic or spectroscopic is to be analyzed as a whole, a single element detector such as:
a Golay cell;
a Bolometer;
a thermocouple;
   or a detector which is:
a photoconductive material;
a photovoltaic material;
comprises Deuterated Triglycine Sulfate (DTGS);
comprises HgCdTe (MCT);
comprises LiTaO3;
comprises PbSe;
comprises PbS; or
comprises InSb;
   can be utilized. When a Source of electromagnetic radiation is functionally combined with a Michelson Interferometer, for instance, this often the case.

A present invention detector system can alternatively comprise means for producing a plurality of separate wavelength ranges from a spectroscopic beam incident thereupon, said system comprising a sequence of at least two elements, each thereof being selected from the group consisting of:
a grating which when presented with an incident spectroscopic beam of electromagnetic radiation produces a spectrum of diffracted dispersed wavelengths and simultaneous therewith an altered spectral content reflected beam of electromagnetic radiation;
a combination dichroic beam splitter-prism which when presented with a spectroscopic beam of electromagnetic radiation produces a spectrum of dispersed wavelengths that transmit through and exit from said prism, and simultaneous therewith an altered spectral content reflected beam of electromagnetic radiation.

In use a spectroscopic beam of electromagnetic radiation from said source thereof is caused to interact with a sample placed on said stage, and then impinge onto a first selected element such that a spectrum of dispersed wavelengths is produced and directed toward a first detector, simultaneous with production of a reflected altered spectral content reflected beam of electromagnetic radiation which is directed to impinge on a second selected element which likewise produces a spectrum of dispersed wavelengths which are directed toward a second detector.

The reflected altered spectral content reflected beam of electromagnetic radiation can be directed to impinge on a beam splitter that directs at least some of said beam onto a third selected element which produces a spectrum of dispersed wavelengths that are directed into a third detector, while continuing to direct at least some of said altered spectral content beam toward said second selected element which continues to direct the limited range spectrum of dispersed wavelengths produced thereby toward said second detector.

Said detector system can comprise at least one selection from the group consisting of:
at least one of said first and second selected elements is/are designed to optimally structure the range of wavelengths exiting therefrom;
at least one of said first and second detectors is/are designed to optimally detect the range of wavelengths input thereinto by said first and second selected elements respectively;
   is functionally enabled.

Said detector system can further comprise more than two selected elements, and in which the reflected electromagnetic beam produced by the second selected element is directed toward at least one selection from the group consisting of:
a dichroic beam splitter and then therefrom impinge onto a third selected element;
directly impinge onto a third selected element;
at least one reflector and then a dichroic beam splitter and then therefrom impinge onto a third selected element; and
at least one reflector and then impinge onto a third selected element.

Said detector system can provide that the third selected element, upon receiving said reflected beam of electromagnetic radiation produces a spectrum of dispersed wavelengths which are directed toward a third detector.

Said detector system can provide that at least one selection from the group consisting of:
said third selected element is designed to optimally structure the range of wavelengths exiting therefrom;
said third detector is designed to optimally detect the range of wavelengths input thereinto by said first and second selected elements respectively;
   is enabled.

Said detector system can provide that a forth element is selected and in which the reflected electromagnetic beam produced by the third selected element or which exits a present dichroic beam splitter associated with said second selected element, is directed toward at least one selection from the group consisting of:
a dichroic beam splitter and then therefrom impinge onto a forth selected element;
directly impinge onto a forth selected element;
at least one reflector and then a dichroic beam splitter and then therefrom impinge onto a forth selected element; and
at least one reflector and then impinge onto a forth selected element.

Said detector system can provide that the forth selected element, upon receiving said reflected beam of electromagnetic radiation produces a spectrum of dispersed wavelengths which are directed toward a forth detector.

Said detector system can provide that at least one selection from the group consisting of:
said forth selected element is designed to optimally structure the range of wavelengths exiting therefrom;
said forth detector is designed to optimally detect the range of wavelengths input thereinto by said first and second selected elements respectively;
   is enabled.

Said detector system can specifically involve a beam of spectroscopic electromagnetic radiation from said sample that is caused to imping onto a grating or a combination dichroic beam splitter-prism which produces said spectrum of diffracted dispersed wavelengths, which spectrum is directed to enter a detector; and simultaneously produces said altered spectral content reflected beam of electromagnetic radiation which is directed to interact with a dichroic beam splitter that causes said altered spectral content reflected beam of electromagnetic radiation to split into two beams, both of which are directed to separate selections from the group consisting of:
a grating which when presented with an incident spectroscopic beam of electromagnetic radiation produces a spectrum of diffracted dispersed wavelengths and simultaneous therewith an altered spectral content reflected beam of electromagnetic radiation;
a combination dichroic beam splitter-prism which when presented with a spectroscopic beam of electromagnetic radiation produces a spectrum of wavelengths that transmit through and exit from said prism, and simultaneous therewith an altered spectral content reflected beam of electromagnetic radiation;
   such that the spectrum of dispersed wavelengths that exit from a present grating or combination dichroic beam splitter-prism are each caused to enter separate detectors.

Said detector system can provide that the spectroscopic beam of electromagnetic radiation from said sample which is caused to impinge onto a first selected element such that a spectrum of dispersed wavelengths is produced and directed toward a first detector, simultaneous with production of an altered spectral content reflected beam of electromagnetic radiation which is directed to impinge on a second selected element which likewise produces a spectrum of dispersed wavelengths which are directed toward a second detector, is the output beam of an ellipsometer or polarimeter which exits the analyzer thereof.

Said detector system can specifically involve a beam of spectroscopic electromagnetic radiation from said sample that is caused to interact with a sequence of elements comprising:
a first grating and first and first detector, wherein the reflected beam exiting said first grating is a zero order beam and is directed to a second grating and second detector.

Said detector system can specifically involve a beam of spectroscopic electromagnetic radiation from said sample that is caused to interact with a sequence of elements comprising:
a first grating and first detector, wherein the reflected beam exiting said first grating is a zero order beam and is directed to a first combination dichroic beam splitter-prism and second detector.

Said detector system can specifically involve a beam of spectroscopic electromagnetic radiation from said sample that is caused to interact with a sequence of elements comprising:
a dichroic beam splitter which sends first and second ranges of dispersed wavelengths, which are substantially above and below a certain wavelength, respectively, each to a selection from the group consisting of:
   a first grating and first detector, wherein the reflected beam exiting said first grating is a zero order beam and is directed to a second grating and second detector; and
   a first grating and first detector, wherein the reflected beam exiting said first grating is a zero order beam and is directed to a first dichroic beam splitter-prism combination and second detector.

Said detector system can specifically involve a beam of spectroscopic electromagnetic radiation from said sample that is caused to interact with a sequence of elements comprising:
a first combination dichroic beam splitter-prism and first detector, and wherein the reflected beam reflecting from said first combination dichroic beam splitter-prism is directed to a first grating and second detector.

Said detector system can specifically involve a beam of spectroscopic electromagnetic radiation from said sample that is caused to interact with a sequence of elements comprising:
a first grating and first detector, wherein the reflected beam produced by said first grating is a zero order beam and is directed to a second grating and second detector, and in which the reflected beam produced by said second grating is a zero order beam directed to a third grating and third detector.

Said detector system can specifically involve a beam of spectroscopic electromagnetic radiation from said sample that is caused to interact with a sequence of elements comprising:
a first grating and first detector, wherein the reflected beam produced by said first grating is a zero order beam and is directed to a first combination dichroic beam splitter-prism and second detector, and in which the reflected beam reflected from said first combination dichroic beam splitter-prism is directed to a third grating and third detector via a dichroic beam splitter.

Said detector system can specifically involve a beam of spectroscopic electromagnetic radiation from said sample that is caused to interact with a sequence of elements comprising:
a first grating and first detector, wherein the reflected beam produced by said first grating is a zero order beam and is directed to a second grating and second detector, and in which the reflected beam produced by said second grating is a zero order beam and is directed to a first dichroic beam splitter-prism combination and third detector.

Said detector system can specifically involve a beam of spectroscopic electromagnetic radiation from said sample that is caused to interact with a sequence of elements comprising:
a first grating and first detector, wherein the reflected beam produced by said first grating is a zero order beam and is directed to a first combination dichroic beam splitter-prism and second detector, and in which the reflected beam reflected from said first combination dichroic beam splitter-prism is directed to a second dichroic beam splitter-prism combination and third detector via a beam splitter.

Said detector system can specifically involve a beam of spectroscopic electromagnetic radiation from said sample that is caused to interact with a sequence of elements comprising:
a first combination dichroic beam splitter-prism and first detector, wherein the reflected beam reflected by said first combination dichroic beam splitter-prism is directed to a second grating and second detector, and in which the reflected beam produced by said second grating is a zero order beam and is directed to a third grating and third detector.

Said detector system can specifically involve a beam of spectroscopic electromagnetic radiation from said sample that is caused to interact with a sequence of elements comprising:
a first combination dichroic beam splitter-prism and first detector, wherein the reflected beam reflected from said first combination dichroic beam splitter-prism is directed to a second dichroic beam splitter-prism combination and second detector, and in which the reflected beam reflected from said second combination dichroic beam splitter-prism is directed to a third grating and third detector via a dichroic beam splitter.

Said detector system can specifically involve a beam of spectroscopic electromagnetic radiation from said sample that is caused to interact with a sequence of elements comprising:
a first combination dichroic beam splitter-prism and first detector, wherein the reflected beam reflected from said first combination dichroic beam splitter-prism is directed to a first grating and second detector, and in which the reflected beam produced by said second grating is a zero order beam and is directed to a second combination dichroic beam splitter-prism and third detector.

Said detector system can specifically involve a beam of spectroscopic electromagnetic radiation from said sample that is caused to interact with a sequence of elements comprising:
a first combination dichroic beam splitter-prism and first detector, wherein the reflected beam reflected from said first combination dichroic beam splitter-prism is directed to a second combination dichroic beam splitter-prism and second detector, and in which the reflected beam reflected from said combination second dichroic beam splitter-prism is directed to a third combination dichroic beam splitter-prism and third detector via a beam splitter.

Said detector system can involve a spectrum of dispersed diffracted wavelengths are produced by a grating is a + or − order spectrum.

It is also to be understood that where relatively shorter wavelengths can be modified to longer wavelengths, which longer wavelengths are to be monitored by, for instance, a Golay Cell, a Bolometer or a Micro-Bolometer etc.) As relatively long wavelengths are provided by the Sources in the present invention, however, the present invention more likely comprises a wavelength modifier for changing relatively longer wavelength electromagnetic radiation to shorter wavelength electromagnetic radiation, in functional combination with, for instance, solid state detector elements which cannot monitor the longer wavelengths, but can monitor the shorter wavelength, higher energy wavelengths.

The typical configuration in the context of the present invention is that the source provides wavelengths in the infrared and/or terahertz ranges, and the detector elements are solid state which can only detect higher energy, shorter wavelengths. However, this does not exclude the situation wherein the wavelength modifier inputs relatively shorter wavelengths and outputs longer wavelengths and the detector elements are Golay Cells, Bolometers, Micro-Bolometers etc. Where solid state detector elements are used, the present invention provides Utility in the form of reduced initial and operational costs, (eg. cooling when longer wavelengths are detected).

In the Claims, where element(s) is recited, the distinction between Detector type is indicated. That is, the Claim should be interpreted to apply to the case where a Detector comprises a single element and monitors monochromatic or all wavelengths of a Spectroscopic beam together, or to the case where wavelengths are separated and monitored individually.

The present invention will be better understood by reference to the Detailed Description of this Specification in conjunction with the Drawings.

### BRIEF DESCRIPTION OF THE DRAWINGS

FIG. 1 demonstrates a number of wavelength ranges in which various multi-channel detectors (DET1) (DET2) (DET3) are designed to handle optimally.

FIG. 2 shows some present invention combinations of multiple Gratings (G) and/or Dichroic Beam Splitter-Prism Combinations (DBSP), (generically represented as (G/P)), as examples that each produce at least one + or − order spectrum of wavelengths as well as a relatively more energetic Reflected Beam, (eg. Zero Order (ZO) in the case of a Grating), beam of electromagnetic radiation, which is directed to a follow-on Grating (G).

FIG. 3a shows a grating (G) that reflects an incoming beam (IB) of electromagnetism, and provides a spectrum of wavelengths (λ) in an order thereof, (eg. the first+Order), along with a Zero Order (ZO).

FIG. 3a′ shows the situation wherein a Reflected (RB) beam is reflected from dichroic beam splitter-prism (DBS-PR) combination at a surface thereof on which is present a Coating, to give it the Dichroic property. Note that a spectrum of at least a + or − order spectrum exits the Prism (P).

FIG. 4 demonstrates an ellipsometer system, in which the present invention finds very relevant application.

FIG. 5 shows the use of sequential follow-on Gratings which electromagnetic radiation sequentially caused to encounter.

FIG. 6 shows the use of beam splitters to direct portions of beams into different detectors which can be optimized to respond to different wavelength ranges.

FIGS. 7a and 7b show, respectively, typical Intensity vs. position in a beam for a beam of electromagnetic radiation provided by a supercontinuum laser source over a range of about 400-2500 nm, and the same results when a Speckle Reducer is applied to the plot of FIG. 7a.

FIGS. 8a-8a′″ show a Fly's Eye approach to reducing Speckle.

FIGS. 8b-8f show various Speckle Reducers.

FIGS. 9a and 9b are included to show a basic reflectometer or spectrophotometer system, and a basic ellipsometer of polarimeter system, respectively, including one or more Wavelength Modifiers (WM).

FIG. 9c shows a basic FTIR system which includes a Source of electromagnetic radiation therein.

FIGS. 9d and 9e show FIGS. 9a and 9b with dispersal optics and Wavelength Modifiers (WM).

FIG. 9f shows a basic reflectometer or spectrophotometer system, with two wave modifiers (WM) present.

FIGS. 9g-9i show further examples of ellipsometer systems with Wavelength Modifiers (WM) present therein.

FIG. 10a is included to show a typical Inventor generated Intensity vs. Wavelength result from a supercontinuum laser, as compared to a typical conventional source of electromagnetic radiation intensity vs. Wavelength.

FIG. 10b is included to show that recent advances have extended the range of supercontinuum lasers to at least 4400 nm, and even up as high as 18000 nm.

### DETAILED DESCRIPTION

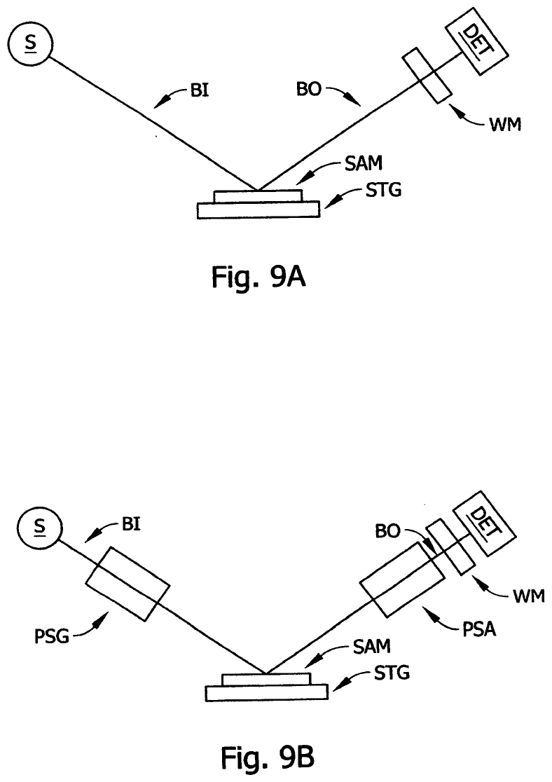

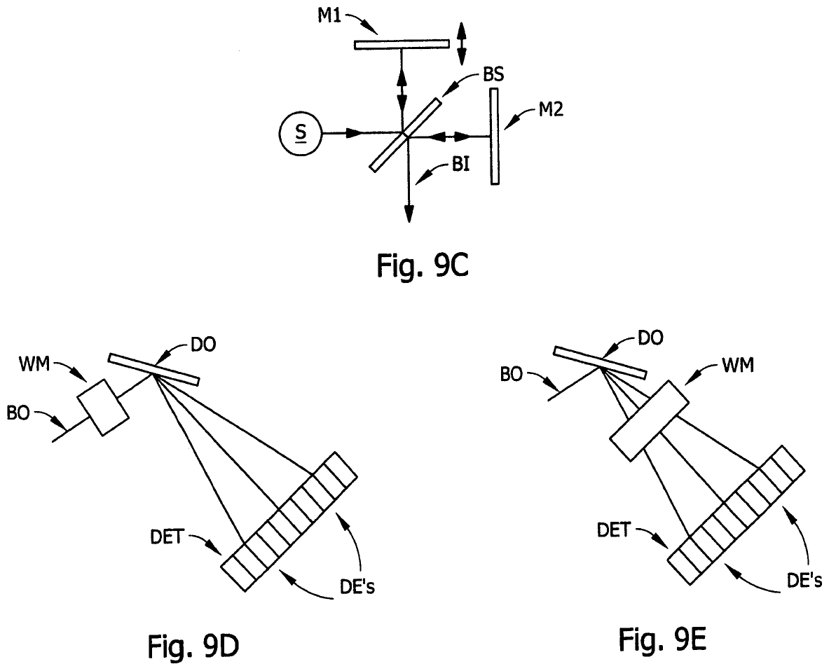

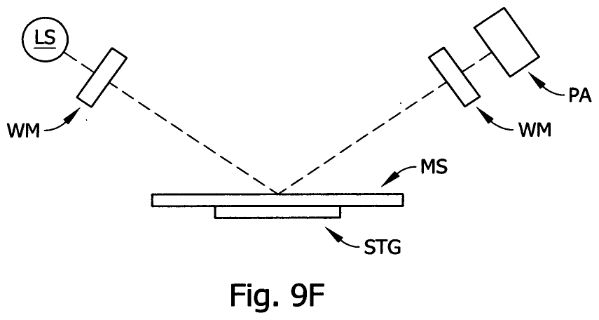

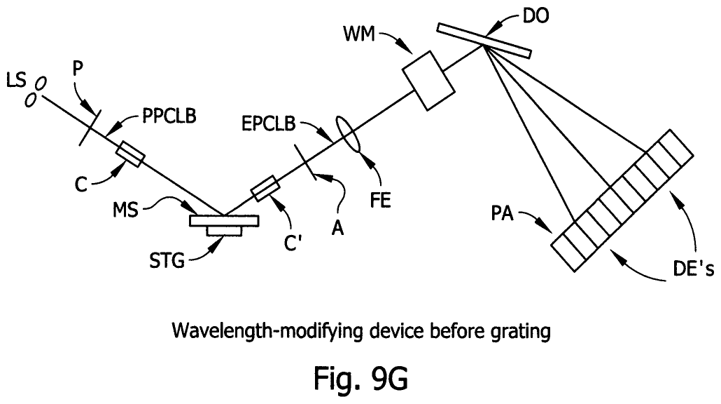

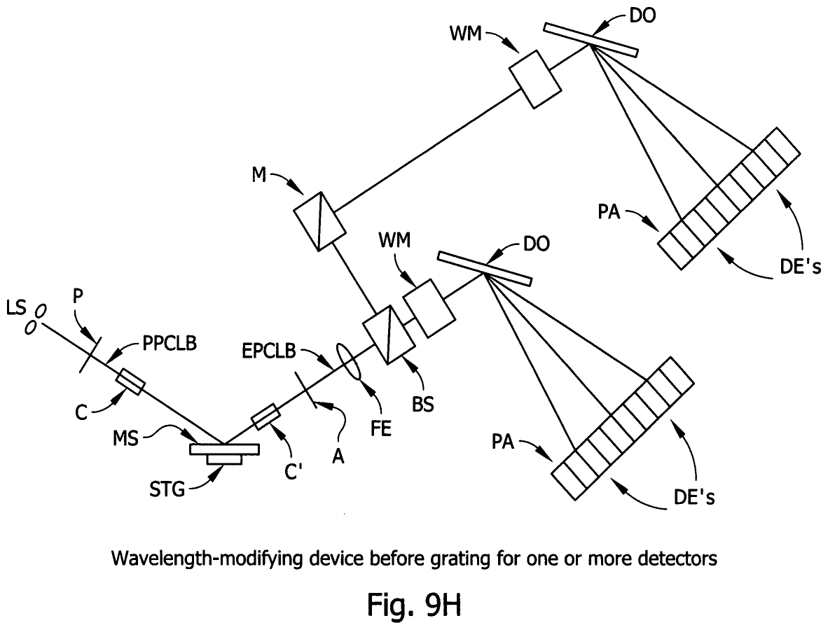

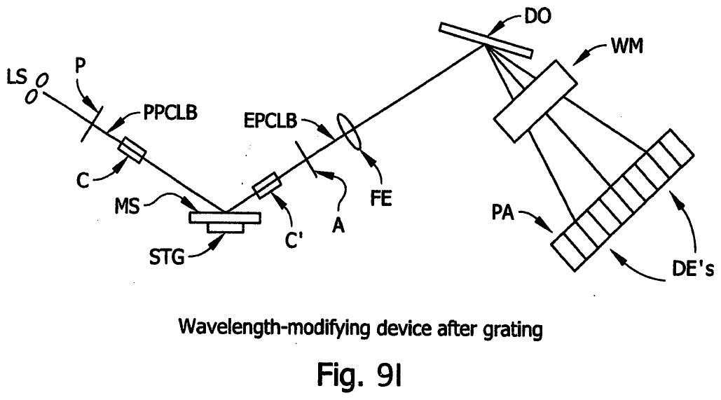

To begin, it is to be appreciated that the Invention Claimed herein is best shown in FIGS. 9F-9J, which concern Wavelength Modifiers (WM) applied in the context of Reflectometers, Spectrophotometers, Ellipsometers and Polarimeter Sample Investigation Systems. Said Wavelength Modifiers (WM) change the Wavelengths of entering electromagnetic radiation, which can be present before or after a Sample (SAM) supporting Stage (STG). However, the Presently Claimed Invention also inseparably involves Sources (LS) and Detectors (PA) of Electromagnetic Radiation. The Drawings herein are adapted from co-pending application Ser. No. 17/300,091 (concerned with Sources (LS) and Detectors (DET)), and are discussed in the order presented therein,

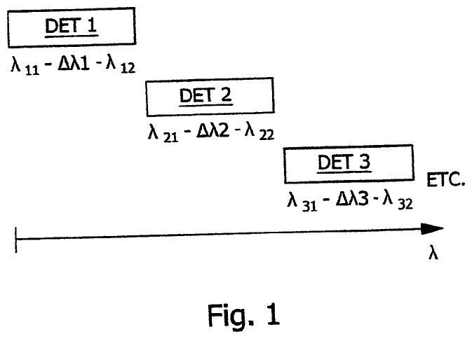

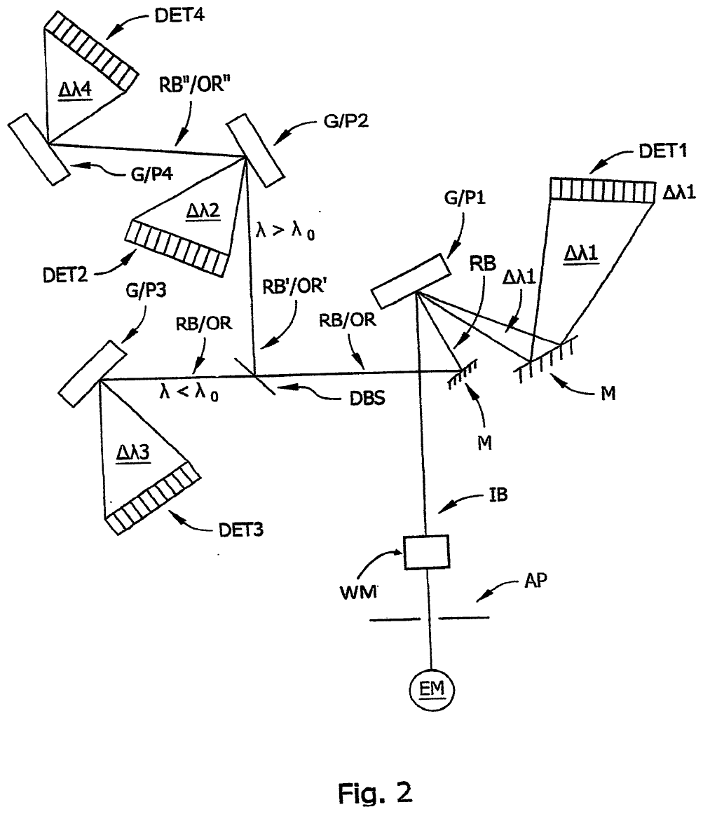

Turning now to FIG. 1, there are demonstrated a number of wavelength ranges in which various multi-channel detectors (DET1) (DET2) (DET3) are designed to handle optimally. Many additional wavelength ranges could be shown similarly as well, such as a (4) as shown in FIG. 2.

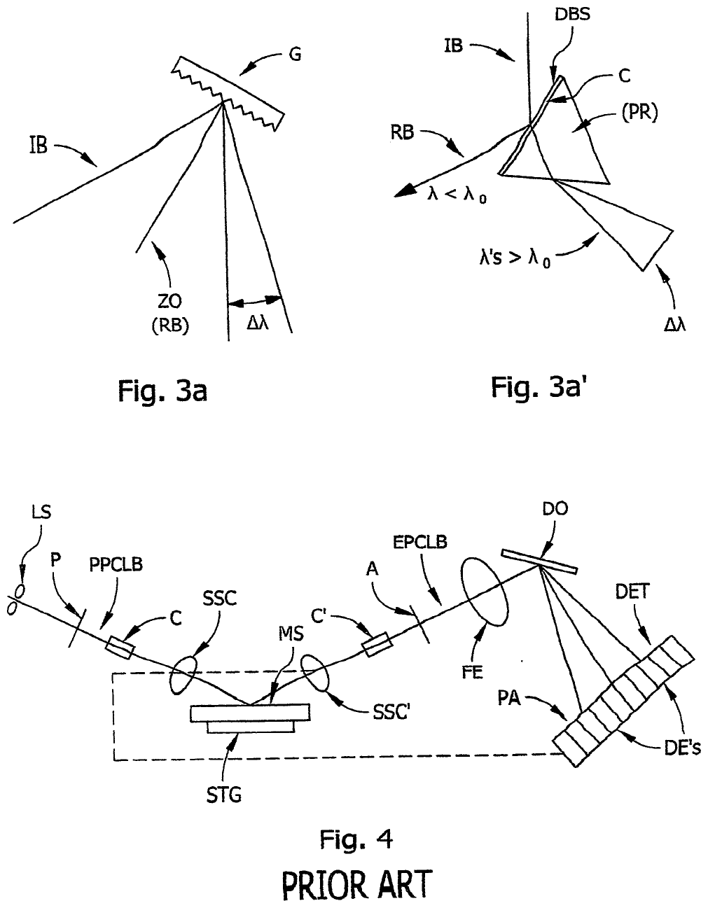

FIG. 2 shows Source (EM) of electromagnetic wavelengths in the Infrared or Terahertz ranges, a typically present Aperture and a demonstrative use of a Wavelength Modifier (WM), for accepting said Infrared or Terahertz wavelengths and typically providing output wavelengths in a range of wavelengths Solid State Detector (DET) Elements (DE's) (see FIG. 4) can detect. FIG. 2 also shows combinations of multiple Gratings (G) (see FIG. 3a) and/or Dichroic Beam Splitter-Prism Combinations (DBS-RP) (see FIG. 3a′) in FIG. 2), that each produce at least one + or − order spectrum (λλ) of wavelengths, as well as an altered spectral content Reflected (RB/OR) beam of electromagnetic radiation, (eg. a Zero Order (OR) beam as in the case of a Grating (G) or a functionally similar Reflected Beam (RB) in the case of a Dichroic Beam Splitter-Prism Combinations (DBS-PR) (both possibilities indicated as G/P− in FIG. 2). See Reflected Beam (RB) in FIG. 3a′ as regards a combination dichroic beam splitter-prism (DBS-PR) and Zero Order (OR) Beam in FIG. 3a. (Note, the terminology Zero Order (ZO) is not correct in a critical sense where a Dichroic Beam Splitter-Prism Combinations (DBSP), rather than a Grating (G) is applied, even though the results provided are functionally similar). FIG. 2 is a relevant example of a Present Invention System Detector System wherein a Source (EM) of a Beam of electromagnetic radiation (IB) is shown to provide electromagnetic radiation through an Aperture (AP), and impinge on (G/P1). Exiting (G/P1) is a First Range of a + or −, typically first Order spectrum of wavelengths (λ) which proceed, via reflection from a Mirror (M) as shown to Detector (DET1). Also shown is Reflected beam (RB) which reflects from another Mirror (M) and encounters a Dichroic Beam Splitter (DBS), which (DBS) directs a first amount of the entering beam to (G/P3) which disperses it into a range of wavelengths (Δ) which are directed into Detector (DET3). A second amount of the Beam entering the (DBS) exits toward (G/P2) which provides a dispersed range of wavelengths (that are directed into Detector (DET2), and also directs a Reflected Beam (RB″/OR″ to (G/P4) which provides a dispersed range of wavelengths (λ) to Detector (DET4). It is to be understood that FIG. 2 is included to show that the Present Invention can comprise a plurality of Detectors (DET's) each of which comprise a plurality of Solid State Detector Elements (DE's) (see FIG. 4) which can detect wavelengths exiting from said Wavelength Modifier (WM) when relatively longer wavelengths (eg. in the IR or THZ ranges) are entered thereinto, and in which said wavelengths detectable by Solid State Detector Elements (DE's) from said Wavelength Modifier (WM) are guided into said Solid State Detector Elements (DE's) via Beam Splitters (DBS) and/or Prism/Dichroic Beam Splitter Combinations (DBS-PR) (see FIG. 3a′) and/or Gratings (G) (see FIG. 3a).

FIG. 3a demonstrates a Grating (G) wherein an Input Beam (IB) of electromagnetic radiation is impinged thereonto, with the result that at least one +/− Order Spectrum of wavelengths is produced along with a Zero Order (ZO) beam.

FIG. 3a′ shows the situation wherein a Reflected (RB) beam is reflected from Dichroic Beam Splitter-Prism (DBS-PR) combination at a surface thereof on which is present a Coating, to give it the Dichroic property. Note that a spectrum of at least a + or − order spectrum exits the Prism (P). A coating (C) is indicated as present on the surface onto which the Input Beam impinges, and serves to form the Dichroic Beam Splitter (DBS). For insight, Dichroic refers to different properties, eg. reflection/transmission of electromagnetic radiation, based on wavelength.

It is to be understood that the designations of (G/P_) in FIG. 2 is to be interpreted as possibly being either of the systems in FIGS. 3a and 3a′.

FIG. 4, (which is FIG. 2 taken from U.S. Pat. No. 7,345,762 to Liphardt et al.), is included to demonstrate an ellipsometer system, in which ellipsometer and polarimeter and the like systems the present invention finds very relevant application. When so applied the beam exiting the ellipsometer polarization state analyzer, (ie. (EPCLB) in said FIG. 4), is beneficially considered as being the beam (IB) shown in accompanying FIG. 2. Roughly, Grating (G1) in FIG. 2 corresponds to Dispersive Element (ie. Grating), (DO) in said FIG. 4. Note that FIG. 4 shows an ellipsometer Source (LS) which provides an ellipsometer beam (PPCLB) which has been polarized by interaction with the shown Polarizer (P). Said beam (PPCLB) is then caused to interact with a shown Sample (MS), which is indicated can be a focused beam at that point. A beam reflected from said Sample (MS) can be re-collimated, and then pass through an Analyzer (A) and emerge as beam (EPCLB), before being focused by (FE) onto a Dispersive Element, (eg. a Grating) (DO), which (DO) serves to disperse wavelengths into a Multi-element Detector (PA). One or two Compensators (C) can also be present as shown in the Polarization State Generator or Analyzer or the system associated with the Polarizer and Analyzer respectively. Again, for correspondence, Dispersive Element (DO) is roughly equivalent to Grating (G1) in FIG. 2. Also shown is indication that the Focusing (SSC) and Recollimating (SSC′) lenses can be controlled as to position to optimize intended effects.

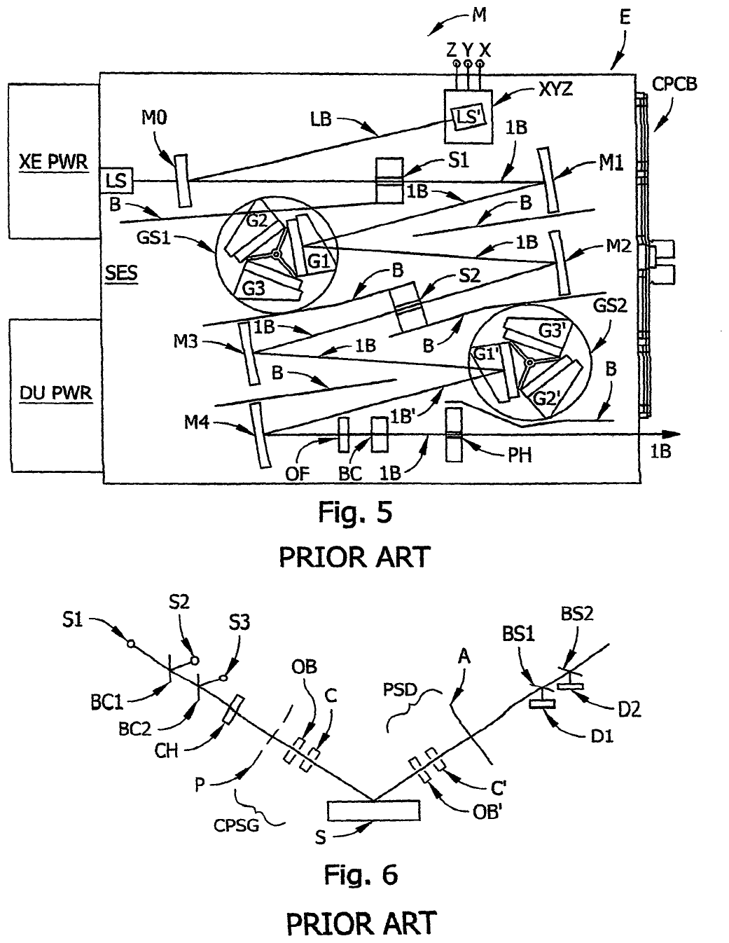

FIG. 5, (from FIG. 9 in U.S. Pat. No. 7,345,762), is included to show the use of sequential follow-on Gratings (eg. G1 and G1′) to arrive at a desired wavelength in a spectrometer system.

FIG. 6, (taken from FIG. 1a in U.S. Pat. No. 8,169,611), is included to show the use of beam splitters (B1 and B2) to direct portions of beams into different detectors (D1 and D2) which can be optimized to respond to different wavelength ranges. See U.S. Pat. Nos. 7,345,762 and 8,169,611 for more clarification. Said Patents however, do not suggest the present invention directing a Reflected altered spectral content Beam to follow-on beam dispersing elements. FIG. 6 also shows the use of beam splitters to direct portions of beams into different detectors which can be optimized to respond to different wavelength ranges.

The +/− orders shown in the Drawings can be described generally as being wavelength ranges that are produced when a grating is presented with an incident spectroscopic beam of electromagnetic radiation and in response produces a spectrum of diffracted dispersed wavelengths, and simultaneous with an altered spectral content reflected beam of electromagnetic radiation, typically a Zero-Order beam.

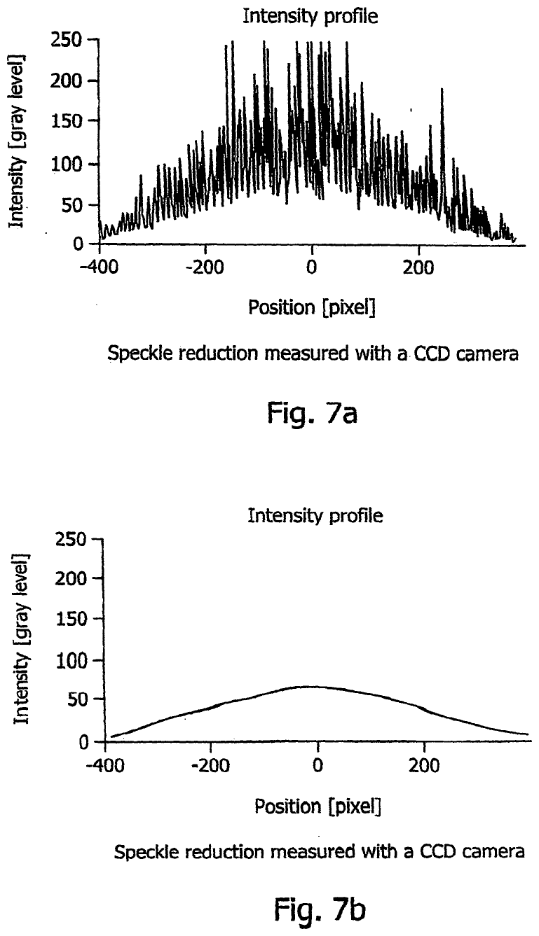

Continuing, FIG. 7a shows a typical Intensity vs. Position within a Beam Cross-section for a beam of electromagnetic radiation provided by a supercontinuum laser source over a range of about 400 to at least 4400 nm. Note in particular that effects of interactions between coherent components thereof leads to a very inconsistent Intensity plot. It is noted that Speckle can lead to Wavelength instability. Supercontinuum lasers can be applied in the presently Claimed Invention to change Wavelengths provided thereby to wavelengths Solid State Detectors can detect, perhaps in conjunction with Wavelength Filters.

FIG. 7b shows that application of a “Speckle Reducer” to the beam Intensity profile in FIG. 6 allows a much more stable beam intensity vs. position in a beam profile to be achieved. This much more stable intensity profile is well suited to application in metrology systems such as ellipsometers, polarimeters, reflectometers and reflectometers. It is believed that use of a Supercontinuum Laser Source and Speckle Reducer as described in this Specification is new and novel, particularly in combination with the also described system of Detectors. As mentioned earlier in this Specification, a coherent source leads to interference effects, the present system comprises a speckle diminisher in the form of a selection from the group consisting of:
a multimode fiber;
a beam diffuser;
a fly's-eye beam homogenizer;
a rotating beam diffuser;
a piezoelectric electric crystal driven beam diffuser;
an electronic means to shorten temporal coherence length;
   to effectively remove wide changes in intensity very small wavelength ranges, (ie. speckle).

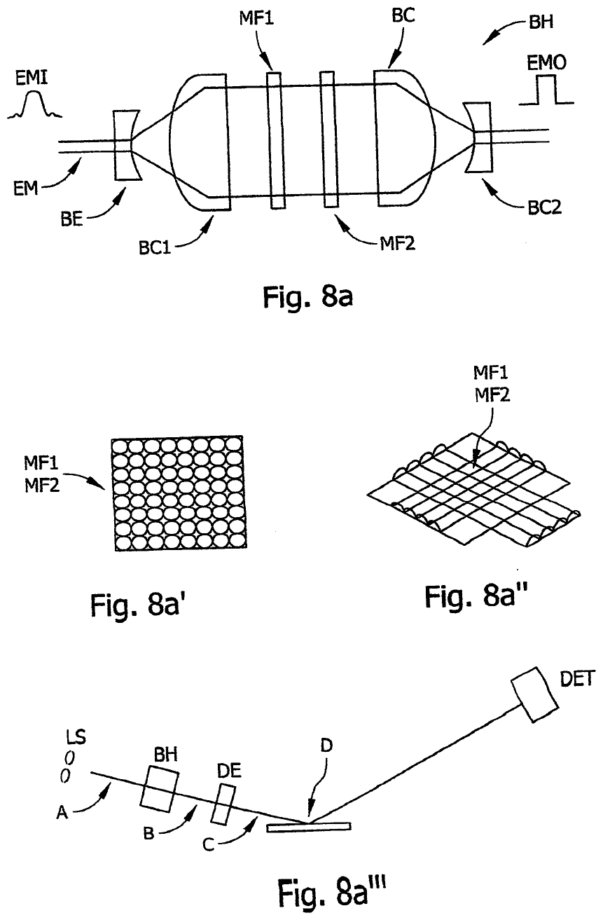

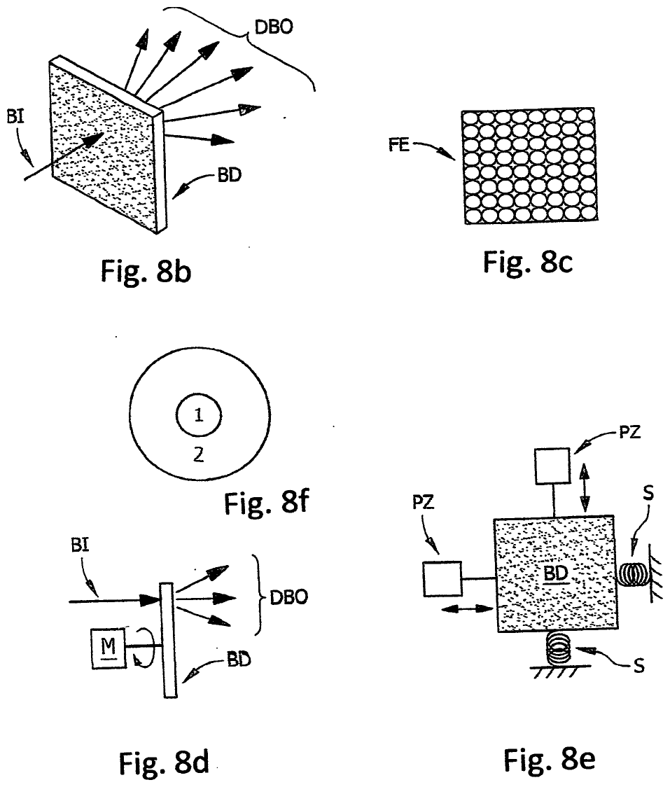

FIGS. 8a-8a′″ show a Beam Homogenizing approach to reducing Speckle. Note that in FIG. 8a shows that input electromagnetic radiation shown as (EMI), which is of a very uneven intensity but can be transformed into output electromagnetic radiation shown as (EMO), which is of a very even intensity. The system consists of a Beam Expander (BE), a Beam Collimator (BC1), two Fly's Eye lenses (MF1) (MF2), a second Beam Collimator (BC2) applied to focus the Collimated beam exiting (MF2), and a Second Beam Collimator (BC2) which re-collimates the beam presented to it. The energy content of (EM1) has been distributed uniformly by the actions of the Fly's Eye lenses (MF1) and (MF2) as indicated by (EMO). FIGS. 8a′ and 8a″ show typical Fly's Eye lens construction. FIG. 8a′″ is included to indicate how the system of FIG. 8a (BH) can be applied in an Ellipsometer system. At “A” the entering beam from Source (LS) is as shown as (EMI), and “B” the beam energy is distributed as is shown by (EMO), and a Polarization Element (DE) can be applied prior to said beam interacting with Sample (and location (D), with a Detector positioned to monitor a reflected beam from said Sample at location (D) thereon.

FIGS. 8b-8f show other various Speckle Reducers. FIG. 8b shows a Beam Diffuser Plate with an Input Beam (BI) entering thereinto, and exiting as Diffused Beam (DBO) components. FIG. 8c a simple Fly's Eye lens (FE) which causes a similar effect as does the Beam Diffuser in FIG. 8b when a beam is passed therethrough. FIG. 8d shows the Beam Diffuser (BD) of FIG. 8b attached to a Motor (M) that causes it to rotate in use. An Input Beam (B) is again passed therethrough as shown, and emerges as a Diffused Beam (DBO). FIG. 8e shows a Beam Diffuser (BD) Plate, again as in FIG. 8b, attached to Piezoelectric Drivers (PZ) that are applied to cause the Beam Diffuser (BD) to vibrate vertically and/or horizontally in use. The Fly's Eye (FE) Lens can also be used in the configurations of FIGS. 8d and 8e. FIG. 8f shows an end-on view of a Multimodal Fiber. Note Core region 1 and Outer region 2. In a Multimode Fiber region 1 is a significant portion of region 2. The Region 1 Core is much less prominent in a Single Mode Fiber.

FIG. 9a is included to show a basic reflectometer or spectrophotometer system comprising:

a) a source (S) of a beam of electromagnetic radiation;

b) a stage (STG) for supporting a sample (SAM);

c) a detector system (DET) of electromagnetism;

said system being distinguished, in the present invention, in that said source (S) of a spectroscopic beam of electromagnetic radiation is a supercontinuum laser that provides an output spectrum as shown FIGS. 7a and preferably 7b. That is, a primary distinguishing aspect of the present invention is the use of a high intensity, highly directional supercontinuum laser to provide electromagnetic radiation. As described earlier with respect to FIG. 2, another aspect of the present invention involves use of detector systems that provide wavelengths of various ranges to detectors that are well suited to detecting said wavelengths.

FIG. 9b shows the elements of FIG. 9a with polarization state generator (PSG) and polarization state analyzer (PSA) added, to effect an ellipsometer or polarimeter system.

(Note, where more than one Source (S) is spoken of in this Specification and the Claims, the indication of (S) in any relevant Figure is to be interpreted to represent the one in use).

It is to be understood that the Detector Systems in the forgoing can provide that there be a plurality of Multiple Element arrays be present as in FIG. 2, or that there be a Single Array as in FIG. 4 or a Single Detector as indicated by FIGS. 9a and 9b. FIGS. 9d and 9e show the Detector side of the systems shown in FIGS. 9a and 9b modified to include Detector (DET) Array Elements (DE's). Note that in FIG. 9e the Wave Modifier (WM) is moved from before a Dispersive Optics (DO) to thereafter. In any configuration the Functional Element(s) that provide a measurable electric signal can be Solid State (eg. a CCD Array), or Single Elements, such as a Golay Cell or Bolometer. The later Detectors can be applied in monitoring Infrared and Terahertz Frequency Electromagnetic Radiation. A Golay Cell converts a Temperature change resulting from electromagnetic radiation into an electrically monitorable signal. For instance a distortable diaphram/film can be present that reflects electromagnetic radiation into one or another Photo Cells. A distortion in the shape of diaphram/film in a chamber of a Golay Cell effects electromagnetic radiation directing into a monitoring Photo Cell. A Bolometer operates by converting changes in electric resistance resulting from impinging electromagnetic radiation onto a blackened material. Further, Detectors can include Wavelength Modifiers where applicable, which Wavelength Modifiers serve to change Far Infrared into Near Infrared frequencies/wavelengths, so that less expensive and easier to use Silicon based elements can be used. FIGS. 9a, 9b 9d and 9e identify the Wavelength Modifiers (WM). An example of an Wavelength Modifier that converts longer wavelength to shorter wavelengths is NLIR Nonlinear Infrared Sensors which change Mid-IR Wavelengths to Near Visible Wavelengths. FIG. 9c is included to indicate that the Source (S) of electromagnetic radiation can be part of a Fourier Transform Interferometer (FTIR) system. Shown are the Source (S), a Beam Splitter (BS) and two Mirrors (M1) and (M2). In use Mirror M1 is caused to move up and down as shown. This increases and decreases the path length of the beam from Beam Splitter (BS) thereto. Various wavelengths transmit and are blocked at different positions of Mirror (M1) because of Interference at the Beam Splitter, between the beams between the Beam Splitter (BS) and Mirror (M1) and between the Beam Splitter (BS) and Mirror (M2).

FIG. 9f shows a basic reflectometer or spectrophotometer system, with two Wavelength Modifiers (WM). Typically only one thereof will be present so two being shown is not to be interpreted as limiting, but note that when only one is present it can be on either side of the stage (STG). When a Wavelength Modifier is present before a Stage (STG), the Sample Investigation System is converted to a system which investigates a Sample (MS) in a different Wavelength range that the Source (LS) of electromagnetic Radiation provides. This can be useful where it is desired to investigate a sample with a very broad range of Wavelengths using the same sample investigation system, without changing Sources (LS) of electromagnetic radiation.

FIGS. 9g-9i show further examples of ellipsometer systems with Wavelength Modifiers (WM) present therein at various locations after a Stage (STG). The systems are shown to comprise Source (LS) of Spectroscopic electromagnetic radiation, a Polarizer (P), a Compensator (C) (note the (P) and (C) in combination comprise a (PSG)), a Sample (MS) on a Stage (STG), a second Compensator (C′) an Analyzer (A) (note the (C′) and (A) comprise a (PSA)), a Focusing Element (FE), a Dispersive Optics (DO) and a Detector (PA) comprising a plurality of Detector Elements (DE's). In FIG. 9g a Wave Modifier (WM) is present between said Stage (STG) and said Dispersive Optics (DO). FIG. 9h further includes a Beam Splitter (BS) and a Mirror (M) to provide two Detector arrangements, both of which have the Wave Modifier (WM) present between said Stage (STG) and said Dispersive Optics (DO). FIG. 9i differs from FIG. 9g in that the Wave Modifier (WM) is present between the Dispersive Optics (DO) and Detector (PA). Any such arrangement is to be considered within the range of the Present Invention. FIGS. 9g-9i demonstrate the positions of Wave Modifiers (WM) in demonstrative Present Invention systems. Note also, that the FIG. 9g configuration can be present in FIGS. 9h-9i. That is a Wave Modifier (WM) can be present between the Source (LS) and Stage (STG) whether the system is a Reflectometer or Spectrophotometer or Ellipsometer or Polarimeter.

It is noted that a Polarizer (P), Analyzer (A) or Compensator(s)(C), (as in FIG. 6 or incorporated onto a Polarization State Generator (PSG) or Polarization State Analyzer (PSA) as in FIG. 9b), can be, in use, stationary, or some or all can be caused to rotate.

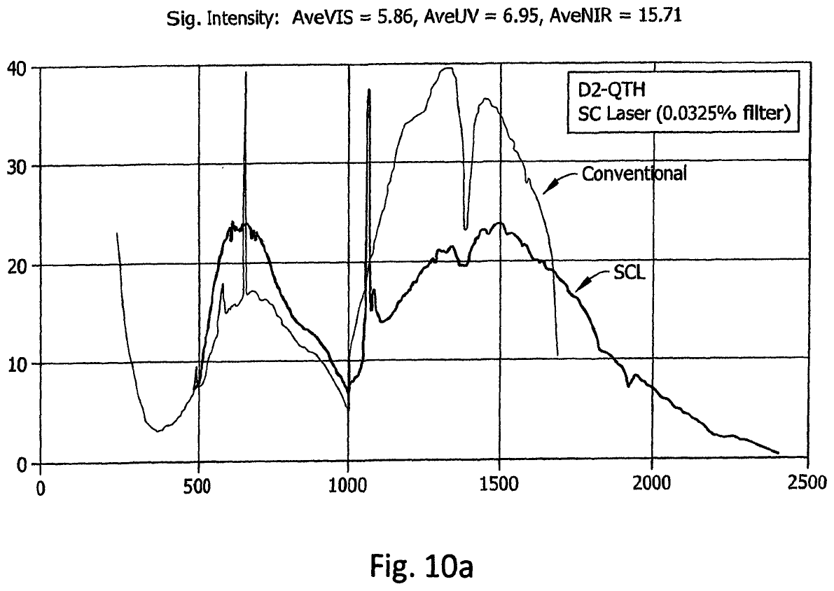

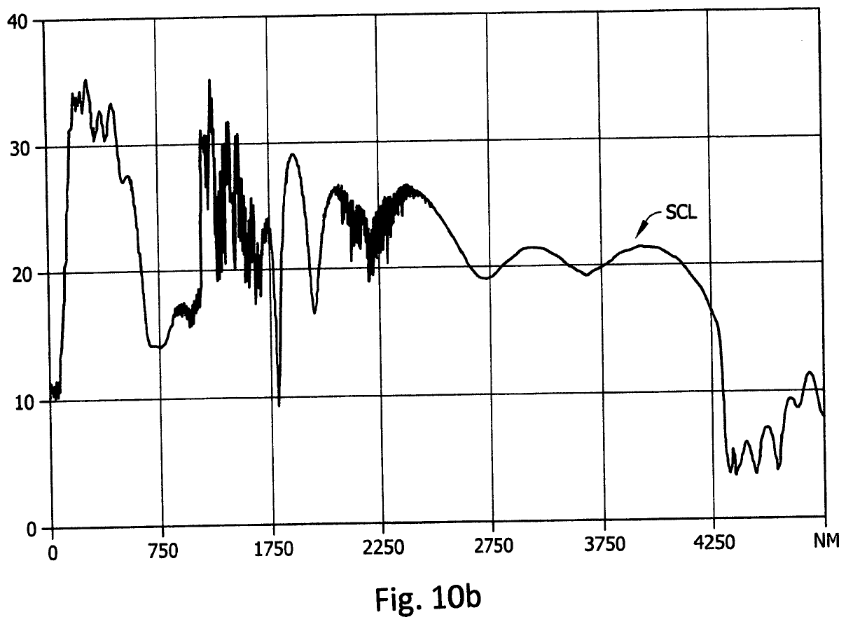

FIG. 10a is included to show a typical Inventor of the present invention generated Intensity vs. Wavelength result from a supercontinuum laser when a 0.0325% neutral density filter is present in the path of the supercontinuum laser beam, as compared to a conventional source of electromagnetic radiation intensity vs. Wavelength. Note, the Supercontinuum Laser intensity is very much greater than that of the Conventional Source Spectrum, (shown as about thirty times greater), and to compare their wavelength spectrum characteristics it was necessary that it be greatly attenuated by a 0.0325 neutral density filter.

FIG. 10b is included to show that progress in Supercontinuum Laser Sources has been made since Parent Applications were filed. Note the greatly expanded Wavelength Range in FIG. 10b as compared to FIG. 10a. It is expected further Wavelength Range expansion will continue and the present invention should be considered in that light. That is the Super Continuum Laser Source Wavelength Ranges shown in FIGS. 10a and 10b are exemplary, not limiting. For instance, Supercontinuum Lasers which provide wavelengths up to 18000 nm are available, though the Intensity at longer wavelengths decreases.

Having hereby disclosed the subject matter of the present invention, it should be obvious that many modifications, substitutions, and variations of the present invention are possible in view of the teachings. It is therefore to be understood that the invention may be practiced other than as specifically described, and should be limited in its breadth and scope only by the Claims.

1.-22. (canceled)

23. A sample investigation system selected from the group consisting of:
an ellipsometer;
a polarimeter;
a reflectometer; and
a spectrophotometer;
for use in investigation samples with electromagnetic radiation; said system comprising:
a source (LS) of electromagnetism;
a stage (STG) for supporting a sample; and
a detector (PA) which comprises detector elements (DE's);
said system source (LS) providing long wavelength electromagnetic radiation in the IR and THZ ranges, and said detector comprising solid state elements (DE's) which cannot detect said IR and THZ wavelengths;
said system being characterized by the presence of, prior to said detector (PA), at least one wavelength modifier (WM) for accepting electromagnetic radiation of wavelengths outside the range of said detector (PA) detector elements (DE's) can detect, and providing output electromagnetic radiation based thereupon of wavelengths which said detector elements (DE's) can detect.

24. A sample investigation system as in claim 23, which further comprises polarization state generator (PSG) and polarization state analyzer (PSA) components before and after said stage (STG) respectively, and the system is an ellipsometer.

25. A sample investigation system as in claim 23, in which the at least one wavelength modifier (WM) accepts electromagnetic radiation comprising wavelengths in the IR and THZ ranges and outputs electromagnetic radiation with wavelengths in the visible wavelength range.

26. A sample investigation system as in claim 23, in which the at least one wavelength modifier (WM) accepts electromagnetic radiation comprising wavelengths in the far-IR ranges and outputs electromagnetic radiation with wavelengths in the visible wavelength range.

27. A sample investigation system as in claim 23, in which the at least one wavelength modifier (WM) accepts electromagnetic radiation comprising wavelengths in the mid-IR ranges and outputs electromagnetic radiation with wavelengths in the visible wavelength range.

28. A sample investigation system as in claim 23, in which the at least one wavelength modifier (WM) accepts electromagnetic radiation comprising wavelengths in the near-IR ranges and outputs electromagnetic radiation with wavelengths in the visible wavelength range.

29. A sample investigation system as in claim 23, which further comprises a dispersion optics (DO) for spatially separating different wavelengths present after said stage (STG), and in which said wavelength modifier is placed between a selection from the group consisting of:
between said source (LS) and said stage (STG);
between said stage (STG) and said dispersive optics (DO);
between said dispersive optics (DO) and said detector (PA).

30. A sample investigation system selected from the group consisting of:
an ellipsometer;
a polarimeter;
a reflectometer; and
a spectrophotometer;
for use in investigation samples with electromagnetic radiation; said system comprising:
a source (LS) of electromagnetism;
a stage (STG) for supporting a sample; and
a detector (PA);
said system source (LS) providing electromagnetic radiation in a wavelength range, longer or shorter than said detector elements (DE's) can detect;
said system being characterized by the presence of, prior to said detector (PA), at least one wavelength modifier (WM) for accepting electromagnetic radiation of wavelengths outside the range of said detector (PA) said state elements (DE's) can detect, and providing output electromagnetic radiation based thereupon of wavelengths which said solid state elements (DE's) can detect.

31. A sample investigation system as in claim 30 in which the source (LS) provides electromagnetic radiation with wavelengths in a range selected from:
ultraviolet;
visual;
far-infrared;
mid-infrared;
terahertz.

32. A sample investigation system as in claim 30 in which said detector detects wavelengths in a range selected from:
ultraviolet;
visual;
far-infrared;
mid-infrared;
terahertz;
said selected range being different from that provided by said source (LS).

33. A sample investigation system as in claim 30, in which the source provides wavelengths in a range selected from:
far-infrared;
mid-infrared;
near infrared; and
terahertz;
and the wavelength modifier provides wavelengths in a range selected from the group consisting of:
ultraviolet; and
visual.

34. A sample investigation system as in claim 30, in which the source of electromagnetic radiation is selected from the group consisting of:
Ar, Xe and He Discharge Lamps in the UV region;
Tungsten Filament Lamps in the Visible region;
Blackbody radiators, Nernst, and Globars in the Infrared ranges;
Hg and Na line producing Lamps in the UV and Visible ranges;
lasers in the and visible and IR ranges; and
super continuum lasers in wavelength ranges of 400 nm to 18000 nm; and
said detector is characterized by a selection from the group consisting of:
Golay cells;
bolometers;
micro-biometers;
thermocouples;
photoconductive materials;
deuterated triglycine sulfate (DTGS);
HgCdTe (MCT);
LiTaO3;
PbSe;
PbS;
InSb; and
silicon, germanium and gallium arsenide solid state devices.

35. A method of investigating a sample comprising the steps of:
a) providing:
an ellipsometer;
a polarimeter;
a reflectometer; and
a spectrophotometer;
for use in investigation samples with electromagnetic radiation; said system comprising:
a source (LS) of electromagnetism;
a stage (STG) for supporting a sample; and
a detector (PA) comprising detector elements (DE's);
said system source (LS) providing electromagnetic radiation in a wavelength range, longer or shorter than said detector elements (DE's) can detect;
said system being characterized by the presence of, prior to said detector (PA), at least one wavelength modifier (WM) for accepting electromagnetic radiation of wavelengths outside the range of said detector (PA) said state elements (DE's) can detect, and providing output electromagnetic radiation based thereupon of wavelengths which said solid state elements (DE's) can detect;
b) placing a sample to be investigated on said stage (STG);
c) causing said source (LS) to provide electromagnetic radiation comprising wavelengths said detector elements (DE's) cannot detect, and direct a beam thereof toward said sample;
d) causing said wavelength modifier to receive electromagnetic radiation wavelengths different from those which were provided by said source (LS), and modify them to wavelengths said detector elements (DE's) can detect;
e) causing said detector elements (DE's) to detect the modified electromagnetic radiation and provide output data;
f) analyzing said output data to determine sample characteristics.

36. A method as in claim 35, in which said system further comprises a dispersive optics (DO) which spatially separates different electromagnetic wavelengths, said wavelength modifier (WM) being positioned between said source (LS) and said detector (PA).

37. A method as in claim 36 in which said at least one wavelength modifier is placed between said source (LS) and said stage (STG).

38. A method as in claim 36 in which said at least one wavelength modifier is placed between said stage (STG) and said dispersive optics (DO).

39. A method as in claim 36, in which said at least one wavelength modifier (WM) is positioned between said dispersive optic (DO) and said detector (PA).

40. A system as in claim 23, which comprises at least two wavelength modifiers between said source (LS) or electromagnetic radiation and said detector (PA).

41. A system as in claim 30, which comprises at least two wavelength modifiers between said source (LS) or electromagnetic radiation and said detector (PA).

42. A method as in claim 35, in which said system comprises at least two wavelength modifiers between said source (LS) or electromagnetic radiation and said detector (PA).

43. A method of investigating a sample with electromagnetic radiation of different wavelengths that provided by a source thereof, comprising the steps of:
a) providing:
an ellipsometer;
a polarimeter;
a reflectometer; and
a spectrophotometer;
for use in investigation samples with electromagnetic radiation; said system comprising:
a source (LS) of electromagnetism;
a stage (STG) for supporting a sample; and
a detector (PA) comprising detector elements (DE's);
said system source (LS) providing electromagnetic radiation in a wavelength range, longer or shorter than said detector elements (DE's) can detect;
said system being characterized by the presence of, prior to said stage (STG), a wavelength modifier (WM);
a) placing a sample to be investigated on said stage (STG);
b) causing said source (LS) to provide electromagnetic radiation and direct a beam thereof toward said sample;
c) causing said wavelength modifier (WM) to receive wavelengths of electromagnetic radiation in a first range as provided by said source (LS) thereof, and emit wavelengths in a modified range;
d) causing said detector elements (DE's) to detect the modified electromagnetic radiation wavelengths after interacting with said sample (MS); and
e) analyzing said output data to determine sample characteristics.

44. A method as in claim 43, which further comprises a step (c′) between steps c) and d) of placing a second wavelength modifier (WM) between said stage (STG) and said detector (PA) to place wavelengths from said sample (MS) in a range detector elements (DE's) in said detector (PA) can detect.
